(19) United States
(12) Patent Application Publication
(10) Pub. No.: US 2008/0103889 A1
(43) Pub. Date: May 1, 2008

(54) Dynamic multi-brand presentation

(75) Inventor: Simon Solotko, Austin, TX (US)

Correspondence Address: ZAGORIN O'BRIEN GRAHAM LLP, 7600B NORTH CAPITAL OF TEXAS HIGHWAY, SUITE 350, AUSTIN, TX, 78731, US

(73) Assignee: Advanced Micro Devices, Inc., Sunnyvale, CA (US)

(21) Appl. No.: 11/588,746

(22) Filed: Oct. 27, 2006

(51) Int. Cl. G06Q 30/00

(52) U.S. Cl. 705/14; 705/26

(57) ABSTRACT

Products and/or services can be marketed in ways that allow configuration or selection of components, features or other attributes for which corresponding branding identities may be associated. In relation to such products, it has been discovered that consumers respond favorably to visually interconnected presentation of brands in which attributes of integration, optimization and/or coherence of a platform solution are suggested. Indeed, some visually interconnected presentations have been found to present a brand ecosystem in which the overall favorable impression of consumers is enhanced beyond that might otherwise be expected based on the individual brands or even the collection of individual brands when presented together, but without visual interconnection.

### BACKGROUND

1. Field of the Invention

The present invention relates generally to branding techniques and, more particularly, to coherent and dynamic presentations of multiple brand associations in connection with configurable or selectable products or services.

2. Description of the Related Art

Branding techniques have long been used to create associations between a product or service and a particular source, supplier, manufacturer, provider, or capability set associated with a standardization or certification process. Indeed, trademarks, and branding generally, serve an important function in our economy by identifying and distinguishing the source of the goods of one party from those of others.

Unfortunately, modern computer and electronics products present a dizzying array of branding opportunities, only some of which correspond to the eventual supplier or retailer of the product. Indeed, for at least some classes of products, a brand associated with a component, feature or certification can be at least as important in motivating purchasers as the primary brand associated with an original equipment manufacturer (OEM), integrator or reseller. Intel Corporation's INTEL INSIDE® campaign is a good example of this phenomenon.

In at least partial recognition of the power of component feature or certification brands, computers marketed in retail channels are typically displayed (and purchased) with collection of affixed stickers signifying at least a processor technology employed and an operating system compatibility. For example, laptop computers that include an AMD TURION™ 64 X2 Dual-Core Mobile Technology processor and which meet the requirements of Microsoft Corporation's Designed for Windows XP logo program are typically marketed with two distinct affixed stickers signifying same.

### SUMMARY

Some products and/or services can be marketed in ways that allow configuration or selection of components, features or other attributes for which corresponding branding identities may be associated. In relation to such products, it has been discovered that consumers respond favorably to visually interconnected presentation of brands in which attributes of integration, optimization and/or coherence of a platform solution are suggested. Indeed, some visually interconnected presentations have been found to present a brand ecosystem in which the overall favorable impression of consumers is enhanced beyond that which might otherwise be expected based on the individual brands or even the collection of individual brands when presented together, but without visual interconnection.

In some marketing channels, purchasers may themselves perform the configuration or may themselves select from a number of pre-configured (or at least partially configured) alternatives. For marketing channels, it is possible to dynamically generate (and indeed vary) relevant sets of brands based on a current configuration or selection and prepare a visually interconnected presentation of a least a subset of the relevant brands. Such a visually interconnected presentation includes at least one conspicuous visual cue that visually connects the relevant brands and, preferably, suggests an integrated, optimized or coherent platform solution for the configured or selected product or service. In some exploitations, the visually interconnected presentation of brands is displayed in correspondence with configuration decisions or selections made by a potential purchaser using an electronic commerce facility such as a website.

In some variations, rule sets or constraints are used to dynamically assemble a suitable visually interconnected presentation of brands based on constituent elements of a current configuration or selection. In some variations, suitable visually interconnected presentations are predefined for possible configurations or selections and are retrieved based on constituent elements of a given configuration or based on a selection identifier. In some variations, the localities associated with individual brands of the visually interconnected presentations may themselves link back to relevant configuration options or otherwise present dynamic content or behavior such as popup information or a hyperlink.

### BRIEF DESCRIPTION OF THE DRAWINGS

The present invention may be better understood, and its numerous objects, features, and advantages made apparent to those skilled in the art by referencing the accompanying drawings.

FIGS. 1 and 2 depict layouts of affixed brand stickers on a laptop computer. FIG. 1 depicts a conventional layout, while FIG. 2 depicts an alterative layout of affixed brand stickers, including additional affixed brand stickers corresponding to additional component brands.

FIGS. 3 and 4 depict layouts of affixed brand stickers for a laptop computer, including exemplary visually interconnected presentations of component brands in accordance with some realizations of the present invention.

FIG. 5 depicts an illustrative electronic commerce configuration for marketing and/or transacting purchases of products and/or services that include configurable components or for which varying multi-component configurations may be selected.

FIG. 6 depicts successive screen states including a progression of visually interconnected presentations of brand images that correspond to successive configuration states in a build-to-order electronic commerce system.

FIGS. 7, 8 and 9 depict flowcharts for preparation of appropriate dynamic multi-brand visual presentations in accordance with some embodiments of the present invention.

FIG. 10 depicts a variety of alternative visually interconnected presentations of component brands and visual cues suitable for use in accordance with some realizations of the present invention.

The use of the same reference symbols in different drawings indicates similar or identical items.

### DESCRIPTION OF THE PREFERRED EMBODIMENT(S)

Techniques have been developed for preparing a visually interconnected presentation of brands based on a current configuration or selection of constituent elements of a product or service. In particular, visually interconnected presentations are described which include at least one conspicuous visual cue that visually connects the relevant brands and which, preferably, suggests an integrated, optimized or coherent platform solution for the configured or selected product or service. In general, the described presentations and techniques differ from conventional techniques based on the use of such visual cues to present a brand ecosystem and, in some cases, based on techniques used to prepare a visually interconnected presentation in correspondence with a dynamic configuration or selections.

While some embodiments in accordance with the present invention take the form of an electronic commerce system in which the visually interconnected presentations of brands are displayed to a potential purchaser and dynamically varied in correspondence with configuration or selection of components or features, for some embodiments, the visually interconnected presentations of brands may be reduced to an article that is (or can be) affixed to a product so configured or selected. For example, in some exploitations, appropriate visually interconnected brand presentations are prepared and then affixed to product in connection with an electronic commerce fulfillment operation.

For concreteness, we describe implementations based on components, feature or capability sets and certifications typical of computer electronics, particularly laptop computers. That said, our techniques are general to a wide variety of product and/or service configurations, including consumer electronics, appliances, automotive products, real-estate products or services, insurance products, etc. In general, our techniques may be exploited in any product or service marketing or selling chain in which components or features may be varied (or selected) and a visually interconnected presentation of corresponding brands is prepared, displayed or supplied. In general, our techniques do not require electronic commerce; however, certain realizations may employ client- and/or server-side facilities often associated with consumer-oriented, web-based eCommerce.

Accordingly, in view of the foregoing and without limitation on the range of offerings or implementations that may be employed in realizations of the present invention, we describe our techniques primarily in the context of web-based eCommerce in involving build-to-order personal and/or laptop computers. Based on these exemplary realizations, and on the claims that follow, persons of ordinary skill in the art will appreciate a broad range of suitable implementations and exploitations.

### Branding Examples and Third Party Trademarks

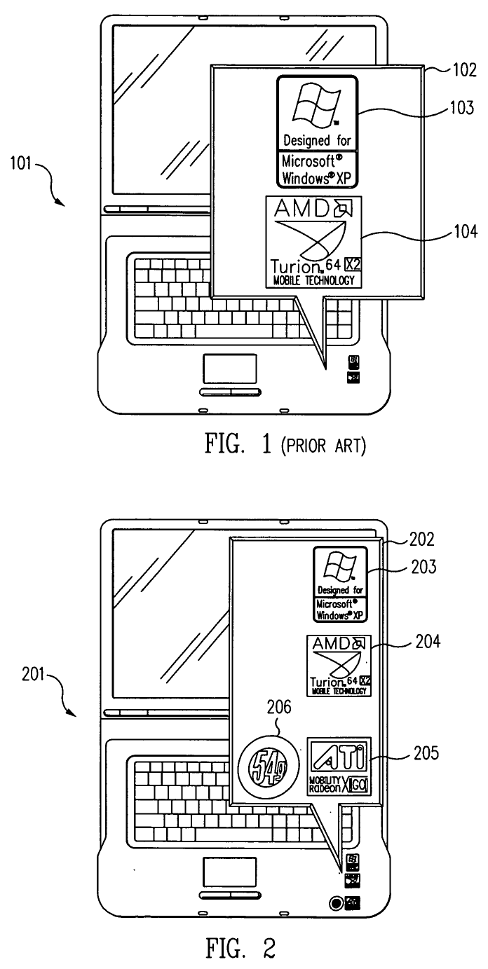

FIGS. 1 and 2 depict layouts of affixed brand stickers on a laptop computer. FIG. 1 depicts a conventional layout, while FIG. 2 depicts an alterative layout of affixed brand stickers, including additional affixed brand stickers corresponding to additional component brands. Referring to FIG. 1, applicant illustrates a conventional configuration of brand stickers 103 and 104 affixed to laptop computer 101. In particular, brand sticker 104 signifies that laptop computer 101 incorporates AMD TURION™ 64 X2 mobile technology (including e.g., an AMD-branded dual core processor), while brand sticker 103 indicates that laptop computer 101 hardware meets requirements of the Microsoft Corporation's “Designed for Windows” Logo Program (e.g., that systems and devices of the laptop design have been tested by the Windows Hardware Quality Lab (WHQL) to ensure that they meet requirements of an operative specification).

FIG. 2 illustrates a similar configuration with a larger set of relevant brands including brands associated with communication and display/graphics device components of laptop computer 201. In particular, applicant illustrates a configuration of brand stickers 203, 204, 205 and 206 affixed to laptop computer 201. As before, brand sticker 204 signifies that laptop computer 201 incorporates AMD TURION™ 64 X2 mobile technology (including e.g., an AMD-branded dual core processor), while brand sticker 203 indicates that laptop computer 201 hardware meets requirements of the Microsoft Corporation's “Designed for Windows” Logo Program. Additional brand sticker 205 signifies inclusion (in laptop 201) of ATI RADEON® graphics card/device technology (including e.g., a RADEON-branded graphics processing unit) from ATI Technologies, Inc. Similarly, additional brand sticker 206 signifies inclusion of Broadcom 54g® Wi-Fi chipset technology (including e.g., a Broadcom-branded card/device for communication over IEEE 802.11g wireless networks) from Broadcom Corporation.

Referring to FIGS. 1 and 2, affixed brand stickers 103 and 104 and affixed brand stickers 203, 204, 205 and 206 are illustrated in expanded view (see expanded views 102 and 202, respectively) and persons of skill in the art will recognize that presentations of the corresponding brand images are not visually interconnected and do not provide any conspicuous visual cue that connects the respective brands. As a result, in the context of FIG. 2, there is no suggestion that the AMD TURION™ 64 X2 mobile technology, ATI RADEON® graphics card/device technology and Broadcom 54g® Wi-Fi chipset technology components of have been incorporated (in laptop 201) in any integrated, optimized or coherent platform solution. Of note, while such components may, in fact, be integrated or optimized to work together in a particular article in commerce, the illustrated branding configuration (see expanded view 202) does not suggest that. Indeed, the illustrated branding configuration can be viewed (by some) as a simple enumeration of unrelated “technology islands” that merely occupy the same chassis. In such case, the illustrated branding configuration may not only fail to suggest (e.g., by visually interconnection) an integrated, optimized or coherent platform solution but may instead suggest to some relevant purchasers exactly the opposite.

Note that in the course of explaining the invented techniques and distinguishing conventional techniques, applicant illustrates branding configurations using images reminiscent of certain visual marks (typically as designs with associated words, letters and/or numbers) including registered and unregistered marks of Advanced Micro Devices, Inc. and those of third parties (including ATI Technologies, Inc., NVIDIA Corporation, Broadcom Corporation, Atheros Communications, Inc. and Microsoft Corporation). While visually interconnected brand presentations that include such third party marks will tend to suggest an integrated, optimized or coherent platform when used in commerce and may (at such time) be subject to co-branding agreements or standards, the illustrations herein do not necessarily imply any relationship between the proprietors of the illustrated marks. The visually interconnected brand presentations shown or described here are for illustration only.

### Dynamic Multi-Brand Presentation

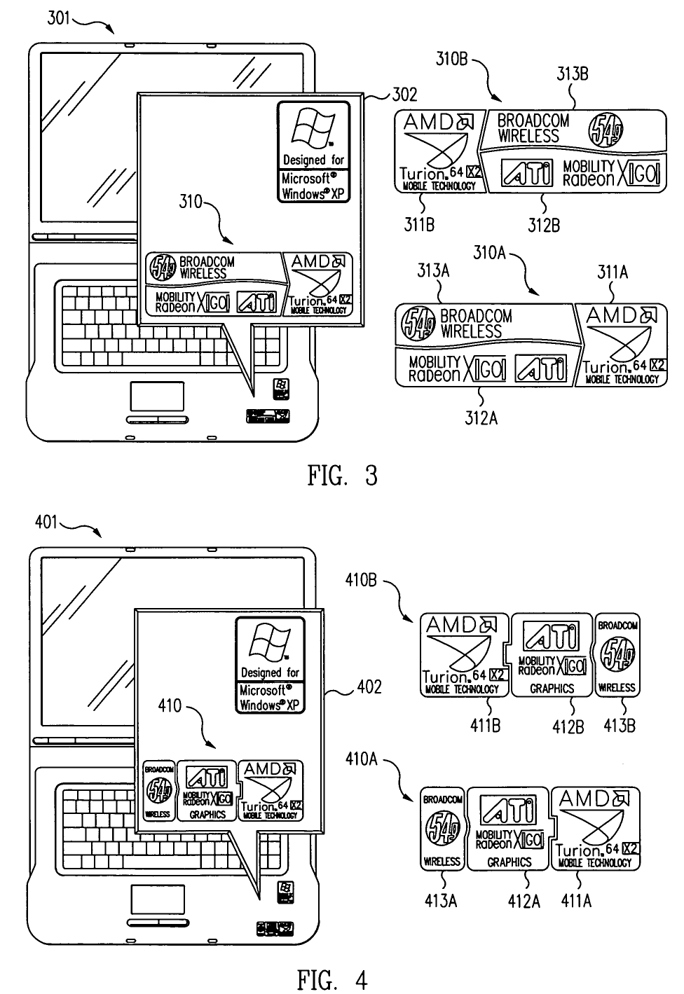

FIGS. 3 and 4 depict layouts of affixed brand images (embodied as one or more stickers) for a laptop computer, including exemplary visually interconnected presentations of component brands in accordance with some realizations of the present invention.

In particular, FIGS. 3 and 4 illustrate at least four alternative realizations of a visually interconnected presentation that includes three brand images. As in the previous example (see FIG. 2), FIGS. 3 and 4 illustrate brand images that signify that a laptop computer (in this case laptop 301 or 401) incorporates AMD TURION™ 64×2 mobile technology (including e.g., an AMD-branded dual core processor), ATI RADEON® graphics card/device technology (including e.g., a RADEON-branded graphics processing unit) and Broadcom 54g® Wi-Fi chipset technology (including e.g., a Broadcom-branded card/device for communication over IEEE 802.11g wireless networks). However, unlike the previous examples, associated brand images are presented in a visually interconnected form (e.g., visually interconnected presentations 310 and 410).

For example, in the expanded view 302 illustration of FIG. 3, a wave-oriented set of complementary boundary contours is used together with a conformal outer envelope to group adjacently-placed brand images into a coherent visually interconnected presentation 310 of constituent brand images corresponding to components of laptop 301. Right-oriented (310A) and left-oriented (310B) variations are shown in which constituent brand images 311A/B, 312A/B and 313A/B correspond to the AMD TURION™, ATI RADEON® and Broadcom 54g® components of laptop 301.

FIG. 4 likewise presents a coherent visually interconnected presentation of constituent brand images. For example, in the expanded view 402 illustration, a puzzle metaphor of complementary boundary contours is used together with a generally conformal outer envelope to group adjacently-placed brand images into a coherent visually interconnected presentation 410 of constituent brand images. As before, right-oriented (410A) and left-oriented (410B) variations are shown in which constituent brand images 411A/B, 412A/B and 413A/B correspond to the AMD TURION™, ATI RADEON® and Broadcom 54g® components of laptop 401.

### Configurable or Selectable Products and/or Services

Building on the preceding description, applicant now details techniques whereby visually interconnected brand presentations can be dynamically assembled (or retrieved) based on configurations or selections of components or features for a product or service. As before, we build on terminology, components and illustrative brands typical of computers, though based on the description herein, persons of ordinary skill in the art will appreciate a wide range of exploitations.

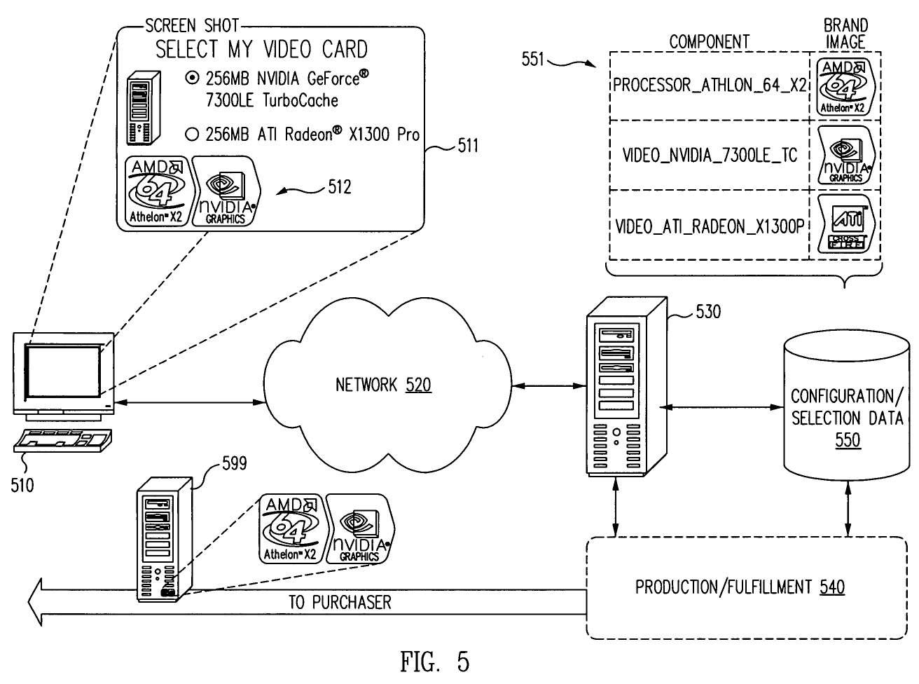

Referring to FIG. 5, applicant illustrates a computer display terminal 510 coupled via a communications network 520 to an electronic commerce application hosted on one or more servers 530. Together, computer display terminal 510, server(s) 530 and software executing thereon provide human users with an interactive facility to configure a desktop-class computer system (or in some variations, to select from amongst systems that are at least partially configured) and to (optionally) purchase a configured or selected system. In some realizations, computer display terminal 510 includes a computer that supports a web browser client and server(s) 530 include(s) web servers, databases, transaction systems and configuration systems such as commonly employed in build-to-order computer retailing or in automotive product market websites. Production and/or fulfillment infrastructure 540 (including that of business partners) and supply chains may be coupled to server(s) 530 to facilitate purchase and delivery of a configured and/or selected computer system, if desired.

Expanded view 511 depicts a screen image for a configuration step in an exemplary build-to-order electronic commerce interaction in which a user selects an NVIDIA-branded video card to include in an AMD ATHLON™ processor-based laptop computer. Based on, and in correspondence with, the user's selection, a visually interconnected presentation 512 of constituent brand images is displayed. As before, complementary boundary contours are used together with a generally conformal outer envelope to group adjacently-placed brand images into a coherent visually interconnected presentation of the constituent AMD ATHLON™ and NVIDIA GEFORCE® brand images.

In some variations, the visually interconnected presentation may present dynamic content or behavior such as popup information or may hyperlink to additional content. In the illustration of FIG. 5, localities associated with the individual brands of visually interconnected presentation 512 may themselves link back to relevant configuration options or otherwise present dynamic content or behavior such as popup information or an internal or external hyperlink to additional content. For example, in certain electronic commerce exploitations, the locality (of visually interconnected presentation 512) generally corresponding to the visual extent of the NVIDIA brand image may support mouse over behavior that pops up additional descriptive/promotional detail or that presents a user with upgrade options or configuration alternatives. Similarly, a locality may be responsive to user inputs (e.g., mouse clicks) and provide a link to additional descriptive/promotional detail, to a brand owner's website or to a relevant configuration/selection step (so as to allow the user to review alternative and/or upgrade options) in the electronic commerce session.

In cooperation with server(s) 530, display terminal 510 displays the selected and/or assembled visually interconnected presentation. FIG. 5 illustrates contents (551) of a configuration database 550 in which individual brand images are associated with components of a possible configuration or selection. In this way, server(s) 530 may supply a display terminal 510 (e.g., an internet connected client executing conventional web browser software) with at least those brand images relevant to a current configuration or with a visually interconnected presentation corresponding to a current configuration. In general, any of a variety of server-side and/or client-side functionality (including scripting support, applets, Java technology, JavaScript, ActiveX, Dynamic HTML, AJaX techniques, etc.) may be employed in modern electronic commerce applications. Therefore, persons of ordinary skill in the art will recognize that either a client or server may assemble constituent brand images to form an encoding of the visually interconnected presentation.

For purposes of illustration, the example of FIG. 5 depicts associations between individual brand images and components of a possible configuration or selection. However, other codings are also possible. For example, in some implementations, preassembled visually interconnected presentations may be coded for display in correspondence with particular configurations or selections (including partial or incomplete configurations or selections). As before, client-side and/or sever-side functionality may be employed in such implementations. Accordingly, either a client or server may select from amongst a set of preassembled visually interconnected presentations for a particular one appropriate to a current configuration or selection.

While the preceding discussion has focused on dynamically prepared (or retrieved) codings of visually interconnected presentations of constituent brand images for display on a display terminal, some realizations may include dynamic preparation (or retrieval) of visually interconnected presentations of brand images for use in tangible, physical form. For example, in exploitations for which production and/or fulfillment is integrated with an electronic commerce front-end, it may be desirable to prepare or select an appropriate visually interconnected presentations of brand images to be affixed to the article in commerce (e.g., built-to-order system 599) or to be included with its packaging.

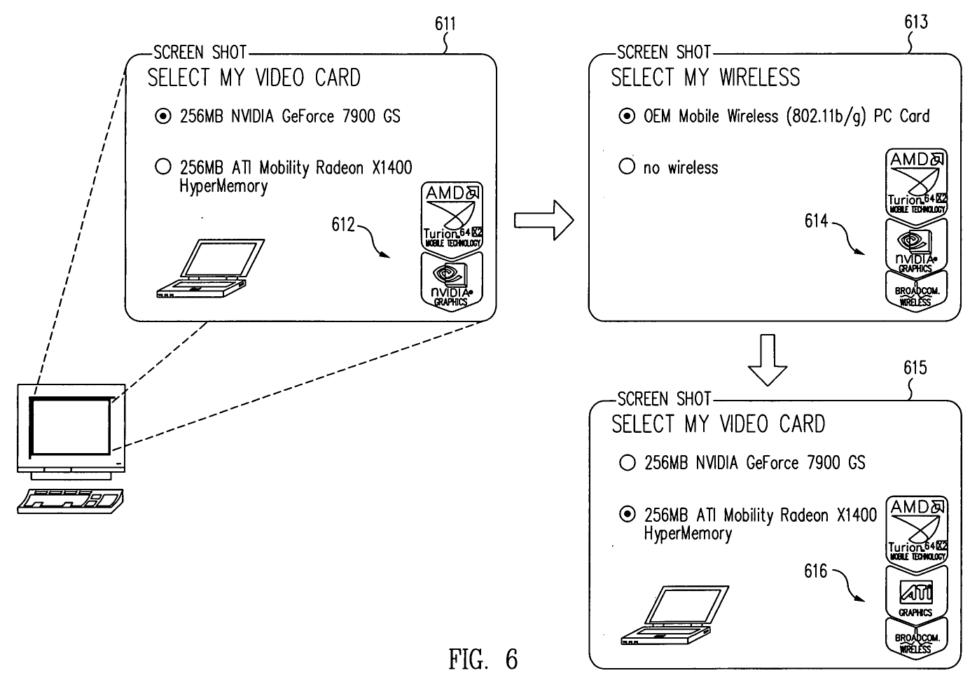

FIG. 6 illustrates a progression of screen images that correspond to successive configuration states in a build-to-order electronic commerce system such as that depicted in FIG. 5. Each of the illustrated screen images 611, 613 and 615 includes a visually interconnected presentation of brand images that corresponds to a then current configuration state of a build-to-order laptop computer. For example, as the user selects an NVIDIA-branded graphics processing unit, an appropriate visually interconnected presentation of brand images 612 appears presenting brand images for an AMD TURION™ 64 X2 dual core processor (previously selected) and the selected NVIDIA GEFORCE®. Similarly, as the user adds a wireless card, an updated visually interconnected presentation 614 of brand images is displayed. Finally, the user reconsiders his graphics card selection and instead selects an ATI RADEON® card. As a result, updated visually interconnected presentation 616 of brand images is displayed. The updated presentation includes of current set of constituent brand images. As before, complementary boundary contours are used together with a generally conformal outer envelope to group adjacently-placed brand images into a coherent visually interconnected presentation of the constituent AMD TURION™, ATI RADEON® and Broadcom™ wireless technology brand images.

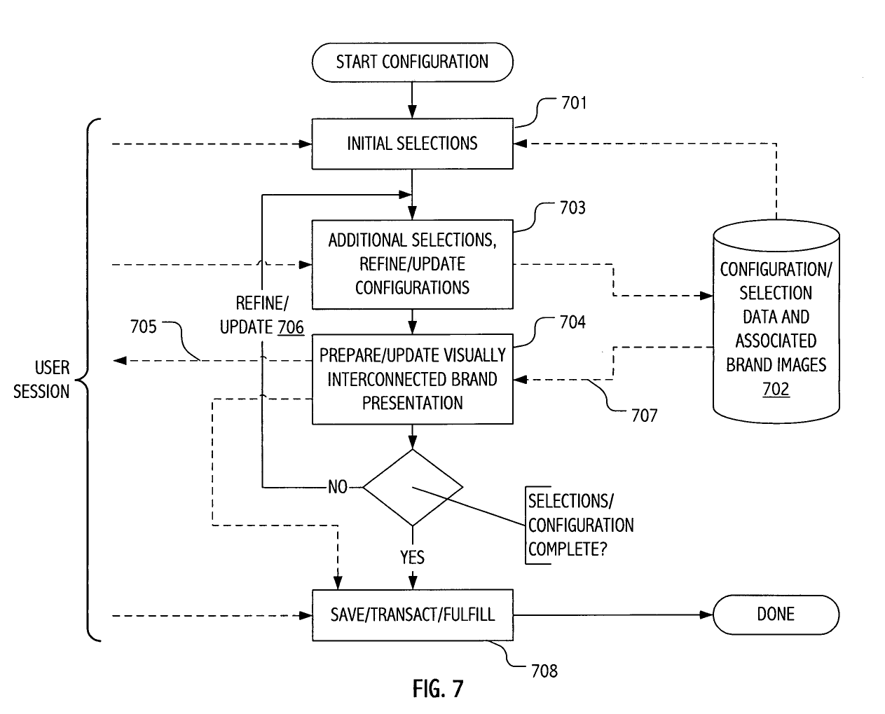

FIGS. 7, 8 and 9 depict operational flows for systems in accordance with some embodiments of the present invention in which visually interconnected brand presentations are prepared and/or retrieved in correspondence with user configuration or selection of components or features of a configurable/selectable product or service. In particular, FIG. 7 illustrates flows in furtherance of a user session (e.g., a user session supported by a system such as illustrated in FIG. 5) in which the user selects, configures and refines a product or service offering. In the illustrated flow, the user initially selects (701) a base configuration (e.g., a laptop model or series) based on stored configuration/selection data 702. In the illustrated flow, additional selections (703) or configuration choices (e.g., selection of a processor, graphic technology, and/or wireless networking support) may be required or possible. In correspondence with the additional selections, a visually interconnected brand presentation is prepared (704) and supplied (705) for display to the user.

In some realizations, individual brand images for constituent elements of the current configuration may be retrieved (707) from store 702 and assembled based on operative positioning, adjacency and/or primacy rules. In some realizations, positioning, adjacency and/or primacy rules may be pre-resolved in the form of precomputed visually interconnected brand presentations that may be retrieved (707) from store 702 based on the current set of constituent elements. In either case, the supplied visually interconnected brand presentation is based on the presently selected/configured product or service (e.g., partially configured laptop) and presents brand images for constituent elements of the product or service in a manner that visually connects the relevant brands and, preferably, suggests an integrated, optimized or coherent platform solution for the configured or selected product or service. Numerous examples of visually interconnected brand presentations are shown and described herein.

In the illustrated user session flow, additional configuration/selection refinements and/or updates (706) are supported and additional or successive selections, refinements and updates are handled similarly. As a result, visually interconnected brand presentations can be updated in correspondence with an evolving configuration as illustrated in FIG. 6. Eventually, the user may choose to save (708) his/her configuration or selections and/or, in some cases, purchase (708) the configured/selected product or service.

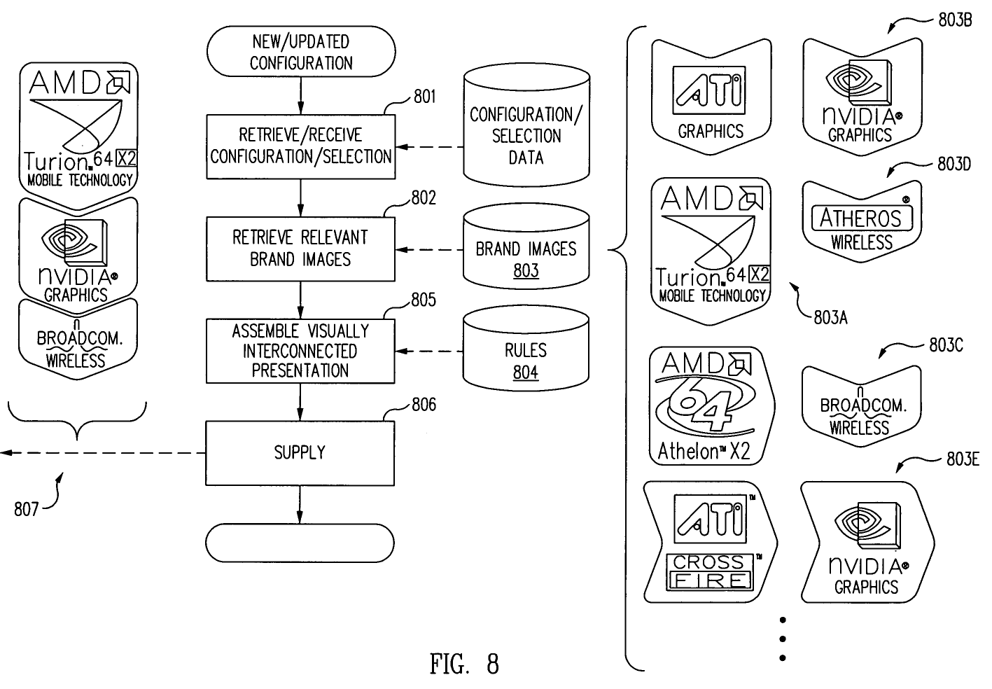

As described, in some realizations, individual brand images for constituent elements of a current configuration may be retrieved and assembled based on operative positioning, adjacency and/or primacy rules. FIG. 8 illustrates one such flow in which configuration and/or selection data is retrieved (801), e.g., based on user selections such as previously illustrated, and brand images corresponding to constituent elements of the current configuration are retrieved for assembly (805) and supply (806) as a visually interconnected presentation 807 of the constituent brands. In the illustrated flow, operative rules 804 are used to constrain the assembly of brand images for a AMD TURION™ 64 X2 dual core processor, a NVIDIA GEFORCE® graphics card and Broadcom wireless technology (e.g., based on chipset technology incorporated in a selected 802.11g compliant wireless card). The result is visually interconnected presentation 807.

In the illustrated example, rules establish a visual primacy relationship of processor brand, then graphics technology brand, then wireless technology brand in vertical orientation and form factor. In general, the rules that define valid interconnected visual presentations are likely to involve agreements between parties owning those brands when more than one party's brands are part of the interconnected visual presentation. Operative rules select brand images corresponding to elements that appear in a current configuration (i.e., constituent image 803C rather than constituent image 803D); however, in some realizations, multiple brand images may correspond to a given component or feature and operative rules may need to select from amongst possible brand images based on some relevant factor. For example, in the illustrated case, two brand images for NVIDIA graphics are available; however, at least based on the vertical orientation of the first constituent image 803A, a vertically-oriented variant is appropriate (i.e., constituent image 803B rather than constituent image 803E). In general, rules may code adjacency or other placement constraints as desirable in the context of a given co-branding campaign. Persons of ordinary skill in the art will recognize a wide variety of suitable coding techniques and/or styles for such rules including constraint-based codings, compatibility tables, simple predicate tests, etc. In general, operative rules 804 are of any suitable coding or style.

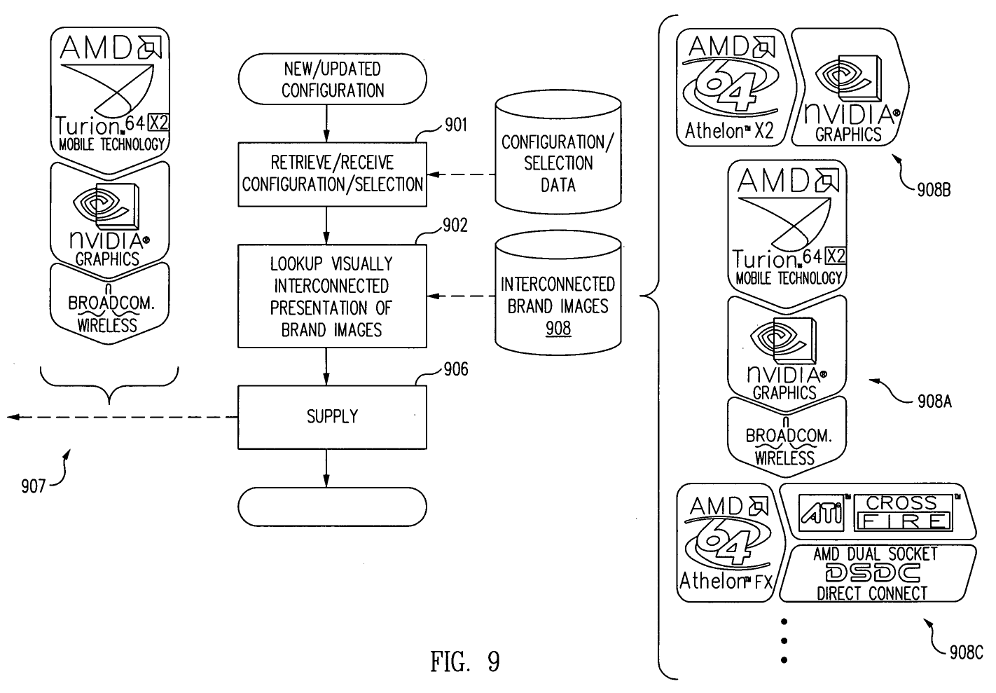

FIG. 9 illustrates an alternative flow in which configuration and/or selection data is retrieved (901), e.g., based on user selections such as previously illustrated, and an appropriate preassembled visually interconnected presentation of brand images is retrieved (902) for supply (906) as the visually interconnected presentation 907 of the constituent brands. In the illustrated example, the visually interconnected presentation 908A is selected (rather than 908B, 908C . . . ) based on the current constituent elements of the configured/selected product. Note that it may be desirable, in some implementations, to store preassembled visually interconnected presentations corresponding to be complete and partial configurations. As with the dynamically assembled presentations, the set of valid preassembled visually interconnected presentations is likely to involve agreements between parties owning those brands when more than one party's brands are part of any interconnected visual presentation.

While numerous variations on visually interconnected presentations of brand images have been illustrated and described herein, persons of ordinary skill in the art will recognize significant opportunities for variation on those illustrations and descriptions. In general, visually interconnected presentations include at least one conspicuous visual cue that visually connects the relevant brands and which, preferably, suggests an integrated, optimized or coherent platform solution for the configured or selected product or service. In many of the illustrations, complementary boundary contours and generally conformal outer envelopes have been employed to group adjacently-placed brand images into a coherent visually interconnected presentation of the constituent brand images. For example, in some illustrations, visual metaphors such as interlocking puzzle pieces or waves are employed. However, suitable visual cues are not limited to boundary contours or outer envelopes. Indeed, elements of the images themselves may suggest the integrated, optimized or coherent nature of a solution.

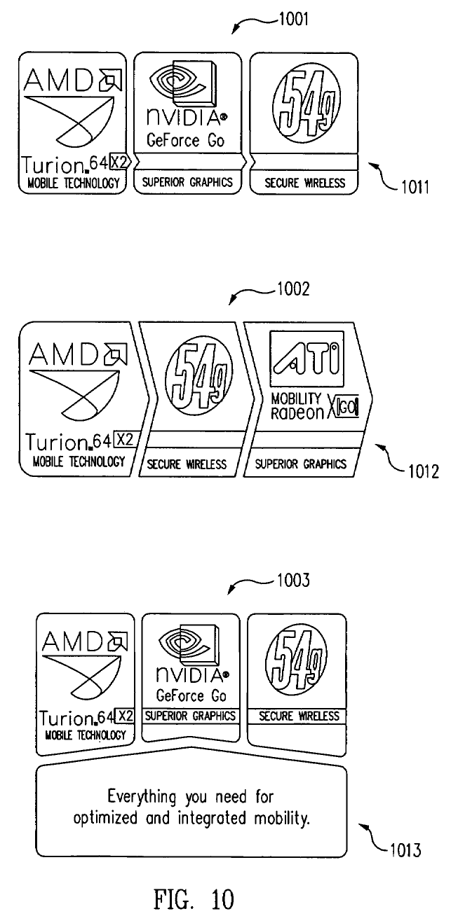

FIG. 10 illustrates several variations in which other connective visual cues are employed. For example, in visually interconnected presentation 1001 a bar and forward arrow device 1011 traverses the multiple brand images and is employed to suggest the integrated, optimized or coherent nature of a solution. Visually interconnected presentation 1002 employs a similar visual technique (see device 1012) with a different set of constituent brand images. Finally, visually interconnected presentation 1003 employs a foundation 1013 metaphor (and accompanying text) to suggest the integrated, optimized or coherent nature of a solution. Based on the description herein, persons of ordinary skill in the art will appreciate a wide variety of suitable visual cues that may be employed in the visually interconnected presentation of constituent brand images.

### Other Embodiments

While the invention(s) is (are) described with reference to various implementations and exploitations, it will be understood that these embodiments are illustrative and that the scope of the invention(s) is not limited to them. In general, the visually interconnected presentations of component brands described herein may be prepared and/or presented using facilities consistent with any particular marketing channel employed. In addition, while our description of branded components and features have been generally consistent with personal computer systems, persons of ordinary skill in the art will recognize that the techniques described may be used in conjunction with any of a variety of goods and services. Indeed, automobiles, major appliances and even residential real estate (including constituent major equipment, appliance, wiring/communications infrastructure and home automation features) may be marketed in ways that advantageously leverage a visually interconnected presentation of component brands. Many variations, modifications, additions, and improvements are possible. For example, while particular visually interconnected presentations and cues have been described in detail herein, other visually suggestive techniques will be understood for conveying an integrated, optimized or coherent branding message.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality (including amongst client and server components of a cooperative system) are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A computer implemented method for visually interconnected presentation of two or more brands corresponding to a product or service, the method comprising:
dynamically generating, based on a current configuration or selection of the product or service, a set of applicable or associated brands;
selecting at least a subset of the applicable or associated brands; and
preparing a visually interconnected presentation of the selected brands, the visually interconnected presentation including at least one conspicuous visual cue that visually connects the selected brands.

2. The method of claim 1,
wherein the preparing includes assembling the visually interconnected presentation from a collection of individual brand images based on a set of rules that constrain at least placement of the individual brand images with respect to each other.

3. The method of claim 1,
wherein the preparing includes selecting the visually interconnected presentation from a preexisting collection thereof based at least in part on the selected brands.

4. The method of claim 3, further comprising:
preparing individual instances of visually interconnected presentations of the preexisting collection thereof based on a rule base that constrains either or both of an ordering of constituent brand images and a location of individual brand images relative to others.

5. The method of claim 1, further comprising:
varying the visually interconnected presentation in correspondence with changes made by a user to the configuration or to a selection of components.

6. The method of claim 1,
wherein the visually interconnected presentation is encoded as one or more computer readable encodings of image information; and
further comprising supplying the image information encodings for rendering on a display device.

7. The method of claim 1, wherein the connective visual cue includes one or more of:
an complementary contour of respective adjacently-placed individual brand images; and
a pair of interlocking tabs and slots of respective adjacently-placed individual brand images.

8. The method of claim 1,
wherein the connective visual cue includes a conformal outer envelope grouping adjacently-placed individual brand images.

9. The method of claim 1,
wherein the product or service includes a build-to-order system.

10. The method of claim 1,
wherein at least two of the selected brands of the visually interconnected presentation are not commonly owned.

11. The method of claim 1,
implemented at least partially as functional code executable in connection with a browser.

12. An electronic commerce system that prepares a visually interconnected presentation of two or more brands corresponding to a product or service, wherein the presentation is dynamic and varies in correspondence with changes made by a user to a configuration or selection of components for the product or service.

13. The electronic commerce system of claim 12,
wherein the visually interconnected presentation includes at least one locality generally corresponding to a visual extent of a constituent brand image, the locality presenting the user with one or more of dynamic content and a hyperlink to additional or related content.

14. The electronic commerce system of claim 12, further comprising:
a display device communicatively coupled to receive one or more image information encodings of the visually interconnected presentation.

15. The electronic commerce system of claim 12, further comprising:
a display device communicatively coupled to receive one or more image information encodings of the visually interconnected presentation.

16. The electronic commerce system of claim 12, further comprising:
a rule base for assembly of the visually interconnected presentation from a collection of individual brand images based on a set of rules that constrain at least placement of the individual brand images with respect to each other.

17. The electronic commerce system of claim 12,
a store of visually interconnected presentations of multiple brands; and
a lookup interface for selecting from the store a particular one the visually interconnected presentations based at least in part on the configuration or selection of components.

18. A computer program product encoded in one or more computer readable media, the program product comprising:
a first functional sequence for dynamically generating, based on a user configuration or selection of the product or service, a set of applicable or associated brand identifiers; and
a second functional sequence for supplying a visually interconnected presentation of brand images corresponding to the generated set of brand identifiers, the visually interconnected presentation including one or more conspicuous visual cues that visually connect the brand images.

19. The computer program product of claim 18,
combined in a computational system with program code to form an electronic commerce information service capable of supplying users with an appropriate instance of the visually interconnected presentation in correspondence with the user configuration or selection of the product or service.

20. The computer program product of claim 18, encoded in at least one computer readable medium selected from the set of a disk, tape or other magnetic, optical or electronic storage medium.

21. A method of making a product, the method comprising:
configuring a multi-component product in correspondence with user selections of components, wherein at least some of the components have associated brand identifiers;
associating a visually interconnected presentation of brand images with the configured multi-component product, wherein the visually interconnected presentation includes at least one conspicuous visual cue that visually connects the brand images and wherein at least one of the brand images corresponds to one of the user selections; and
at least partially assembling the configured product in accordance with the user selections.

22. A method of making a product, as recited in claim 21, further comprising:
supplying the user with an image of the visually interconnected presentation in connection with an electronic commerce session in which the user performs the configuring.

23. A method of making a product, as recited in claim 21, further comprising:
affixing the visually interconnected presentation to the configured product for shipment.
